(19) United States
(12) Patent Application Publication
(10) Pub. No.: US 2022/0270589 A1
(43) Pub. Date: Aug. 25, 2022

(54) INFORMATION PROCESSING DEVICE, INFORMATION PROCESSING METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi (JP)

(72) Inventors: Yumi ICHIMURA, Abiko (JP); Takehiro ISHII, Kawasaki (JP)

(73) Assignees: KABUSHIKI KAISHA TOSHIBA, Tokyo (JP); TOSHIBA DIGITAL SOLUTIONS CORPORATION, Kawasaki-shi (JP)

(21) Appl. No.: 17/663,359

(22) Filed: May 13, 2022

Related U.S. Application Data
(63) Continuation of application No. PCT/JP2020/044012, filed on Nov. 26, 2020.

(30) Foreign Application Priority Data
Nov. 27, 2019 (JP) 2019-214360

(51) Int. Cl. G10L 15/04; G06F 40/284; G06F 40/247; G06F 40/289

(52) U.S. Cl. CPC G10L 15/04; G06F 40/284; G06F 40/247; G06F 40/289

(57) ABSTRACT

According to an embodiment, the information processing device includes a dividing unit that divides a first-type keyword into first-type words, and divides a text into second-type words; includes an extracting unit that extracts, from the text, at least either a word string in which the second-type word matching with the leading first-type word of the first-type keyword is included as the leading word, or a word string in which the second-type word matching with last first-type word of the first-type keyword is included as the last word; and includes a detecting unit that detects a second-type keyword based on at least either the degree of character similarity indicating the similarity in character between the word string and the first-type keyword, or the degree of composition similarity indicating the similarity in composition between the word string and the first-type keyword.

### CROSS-REFERENCE TO RELATED APPLICATIONS

This application is a continuation of PCT International Application No. PCT/JP2020/044012 filed on Nov. 26, 2020 which claims the benefit of priority from Japanese Patent Application No. 2019-214360, filed on Nov. 27, 2019, the entire contents of which are incorporated herein by reference.

### FIELD

Embodiments described herein relate generally to an information processing device, an information processing method, and a computer program product.

### BACKGROUND

Conventionally, a technology is known in which, for example, using speech interaction, item values are detected from a text that is obtained by performing speech recognition, and the item values are input into slots (item fields) included in form data.

However, in the conventional technology, if expressions matching with predefined item names are not present, it becomes difficult to identify the slots in which the item values are to be set.

### BRIEF DESCRIPTION OF THE DRAWINGS

FIG. 1 is a diagram illustrating an exemplary functional configuration of an information processing device according to a first embodiment;

FIG. 2 is a flowchart for explaining an example of the operations performed by an extracting unit according to the first embodiment;

FIG. 3 is a flowchart for explaining an example of the operations performed by a detecting unit according to the first embodiment;

FIG. 4 is a diagram illustrating an example of the processing result obtained by the detecting unit according to the first embodiment;

FIG. 5 is a diagram illustrating an exemplary functional configuration of an information processing device according to a second embodiment;

FIG. 6 is a diagram illustrating an example of a thesaurus according to the second embodiment;

FIG. 7 is a flowchart for explaining an example of the operations performed by an extracting unit according to the second embodiment;

FIG. 8 is a diagram illustrating an exemplary functional configuration of an information processing device according to a third embodiment;

FIG. 9A is a diagram illustrating a first example of an item name database according to the third embodiment;

FIG. 9B is a diagram illustrating a second example of the item name database according to the third embodiment;

FIG. 10 is a flowchart for explaining an example of the operations performed by an estimating unit according to the third embodiment;

FIG. 11 is a diagram illustrating an example of a response sentence template according to the third embodiment;

FIG. 12 is a flowchart for explaining an example of the operations performed by a notifying unit according to the third embodiment; and

FIG. 13 is a diagram illustrating an exemplary hardware configuration of the information processing devices according to the first to third embodiments.

### DETAILED DESCRIPTION

An information processing device according to an embodiment includes a hardware processor configured to function as a dividing unit, an extracting unit, and a detecting unit. The dividing unit divides a first-type keyword into first-type words, and divides a text into second-type words. The extracting unit extracts, from the text, at least either a word string in which a second-type word matching with a leading first-type word of the first-type keyword is included as a leading word, or a word string in which the second-type word matching with a last first-type word of the first-type keyword is included as a last word. The detecting unit detects a second-type keyword based on at least either a degree of character similarity indicating a similarity in character between the word string and the first-type keyword, or a degree of composition similarity indicating a similarity in composition between the word string and the first-type keyword.

Exemplary embodiments of an information processing device, an information processing method, and a computer program product are described below in detail with reference to the accompanying drawings.

### FIRST EMBODIMENT

Firstly, the explanation is given about the example in which, using speech interaction, item values are detected from a text that is obtained by performing speech recognition, and the item values are input into slots (item fields) included in form data.

For example, consider the case in which, using speech interaction, item values are input into the form data having three slot values as given below. In the brackets, the data types of the respective items are specified.

“ [symbol] ”/“visit venue” (company name type)

“ [symbol] ”/“visit day” (date type)

“ [symbol] ”/“next visit day” (date type)

In the case of performing a speech input, when the user is not familiar with the system, it becomes easy for the user to understand if an interface is provided that enables inputting one item at a time according to the system guidance as given below.

SYS: “ [symbol] [symbol] [symbol] [symbol] ”

“Inputting of business report starts. Input the visit venue.”

USR: “ABC [symbol] ”/“ABC Trading Company.”

SYS: “ [symbol] [symbol] ”/“Input visit day.”

USR: “8 [symbol] 21 [symbol] ”/“8/21.”

SYS: “ [symbol] [symbol] ”/“Input next visit day.”

USR: “9 [symbol] 11 [symbol] ”/“9/11.”

In this method, since the system specifies the concerned slot (“ [symbol] ”/“visit venue”, “ [symbol] ”/“visit day”, or “ [symbol] ”/“next visit day”), there is no need to identify the item name from the user utterance.

On the other hand, once the user gets familiar with the system, such type of guidance becomes cumbersome, and it is convenient if a plurality of slots can be collectively input by way of talking. The example is given below.

SYS: “ [symbol] [symbol] ”/“Input business report.”

USR: “ [symbol] ABC [symbol] [symbol] 21 [symbol] 9 [symbol] 11 [symbol] ”

“The visited company is ABC Trading Company, the visited day is 8/21, and the following visit day is 9/11.”

If the form data does not contain a plurality of slots of the same data type; then the item values can be input in the slots using the data types as the guide. For example, assume that the form data is configured with two slots, namely, “ [symbol] ” and “ [symbol] ”, and assume that the user utters the following: “ [symbol] [symbol] ABC [symbol] [symbol] 8 [symbol] 21 [symbol] ”/“The visited company is ABC Trading Company and the visited day is 8/21.” Then, for example, using the named-entity extraction technology, it can be understood that “ABC [symbol] ” represents the company name type and “8 [symbol] 21 [symbol] ” represents the date type. Hence, data types can be used as the guide instead of using the item names; and it can be determined that “ABC [symbol] ” representing the company name type should be inserted in the visit destination slot and that “8 [symbol] 21 [symbol] ” representing the date type should be inserted in the visit date slot.

However, if there are two slots of the date type, namely, “ [symbol] ” and “ [symbol] ”; then the system cannot determine whether “8 [symbol] 21 [symbol] ” should be inserted in the visit date slot or in the next visit date slot. In this way, when the slots are not specified by the system, there arises a case in which the item name needs to be identified from the user utterance.

At that time, if the user utterance includes the use of expressions such as “ [symbol] ”, “ [symbol] ”, and “ [symbol] ” that are specified in the slot definitions; then it becomes easy to collate the item names and the slots. However, if the user utterance includes the use of expressions such as “ [symbol] ”/“visited company”, “ [symbol] ”/“visited day”, and “ [symbol] ”/“following visit day” that are not specified in the slot definitions, then it becomes difficult to identify the slots.

Generally, the slot definitions are set by the administrator who prepares the form of the report. Hence, the user is not aware about the expressions used for defining the item names in the slots. Moreover, at the time of setting the slot definitions, it is easy to use the expressions of Chinese origin that represent the written language. On the other, at the time of talking, it is easy to use the colloquial expressions that represent the spoken language. Thus, having a mismatch with the uttered item names can be a frequent occurrence.

In order to deal with that issue, it is possible to think of a method in which, at the time of defining the slots, the administrator also registers paraphrastic expressions of the item names. However, regarding “ [symbol] ”/“next visit day”, there can be various paraphrastic expressions such as “ [symbol] ”/“following visit day”, “ [symbol] ”/“day to visit next”, “ [symbol] ”/“next scheduled visit day”, or “ [symbol] ”/“visit scheduled day next” Thus, it is not possible to comprehensively list the possible expressions of various users.

Alternatively, it is also possible to think of a method in which a thesaurus is used, or a method of finding similar expressions based on the statistical processing from an enormous volume of language resources available on the Internet. However, from such general-purpose data, it is not always possible to obtain the paraphrastic expressions that are required in the form data defined according to the objective.

The following explanation is given about a detection device according to a first embodiment that, even when an utterance does not include any matching expressions to the predefined item names, detects similar expressions from the utterance and enables identification of the corresponding slots, without having to prepare for the paraphrastic expressions of the item names.

The following explanation is given with reference to the accompanying drawings.

### Exemplary Functional Configuration

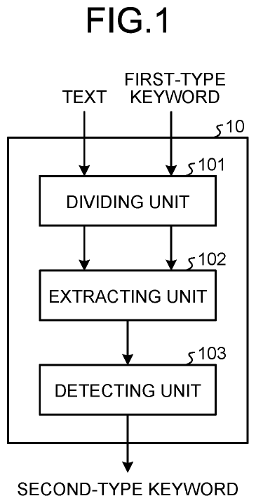

FIG. 1 is a diagram illustrating an exemplary functional configuration of an information processing device 10 according to the first embodiment. The information processing device 10 according to the first embodiment includes a dividing unit 101, an extracting unit 102, and a detecting unit 103.

The information processing device 10 according to the first embodiment is implemented using a computer that reads a computer program recorded in a recording medium such as a memory, or a magnetic disk, or an optical disk; so that the operations of the computer are controlled by the computer program.

The dividing unit 101 receives a first-type keyword and a text. The first-type keyword indicates the name (item name) of a slot (item field) included in the form data, which is used in, for example, the report of door-to-door sales or the report of a maintenance task. The text is obtained by performing, for example, speech recognition of a user utterance. Meanwhile, the speech recognition can alternatively be performed in the information processing device 10. For example, when the dividing unit 101 performs speech recognition, it obtains the user utterance and recognizes a text from the utterance.

The dividing unit 101 divides the first-type keyword into first-type words, and divides the text into second-type words.

For example, assume that “ [symbol] ” represents the first-type keyword, and assume that “ [symbol] 8 [symbol] 21 [symbol] ”/“the visited day is 8/21.” represents the text. In that case, “ [symbol] ” and “ [symbol] ” represent the first-type words. Moreover, “ [symbol] ”, “ [symbol] ”, “ [symbol] ”, “ [symbol] ”, “ [symbol] ”, “8”, “ [symbol] ”, “21”, “ [symbol] ”, “ [symbol] ”, and “ [symbol] ” represent the second-type words.

The division into words can be implemented using, for example, morphological analysis. However, dividing the words into morphological units is not necessarily required. For example, the dividing unit 101 can divide the first-type keyword and the text after every N number of words (characters), or can divide the first-type keyword and the text using the character types or the special symbols as the delimiters.

The extracting unit 102 extracts, from the text, at least either a word string in which the second-type word matching with the leading first-type word of the first-type keyword is included as the leading word, or a word string in which the second-type word matching with the last first-type word of the first-type keyword is included as the last word.

For example, assume that “ [symbol] ” represents the first-type keyword, and assume that “ [symbol] 8 [symbol] 21 [symbol] ”/“the visited day is 8/21.” represents the text. In that case, “ [symbol] ”, “ [symbol] ”, “ [symbol] ”, or “ [symbol] ” represents the word string in which a second-type word matching with the leading first-type word of the first-type keyword is included as the leading word. Moreover, “ [symbol] ”, “ [symbol] ”, “ [symbol] ”, or “ [symbol] ” represents the word string in which the second-type word matching with the last first-type word of the first-type keyword is included as the last word.

As a result of focusing on the leading word or the last word of the first-type keyword, it becomes possible to narrow down to the character strings that are possibly similar to the first-type keyword. That enables achieving reduction in the number of combinations of the character strings. Regarding the operations performed by the extracting unit 102, the detailed explanation is given later.

The detecting unit 103 detects a second-type keyword based on the degree of character similarity indicating the similarity between the characters of the extracted word string and the characters of the first-type keyword, and based on the degree of composition similarity indicating the similarity between the composition of the extracted word and the composition of the first-type keyword. As a result of taking into account the similarity of the characters as well as the similarity of the compositions, it becomes possible to detect a more appropriate keyword as the second-type keyword. Regarding the operations performed by the detecting unit 103, the detailed explanation is given later.

### Example of Operations of Extracting Unit

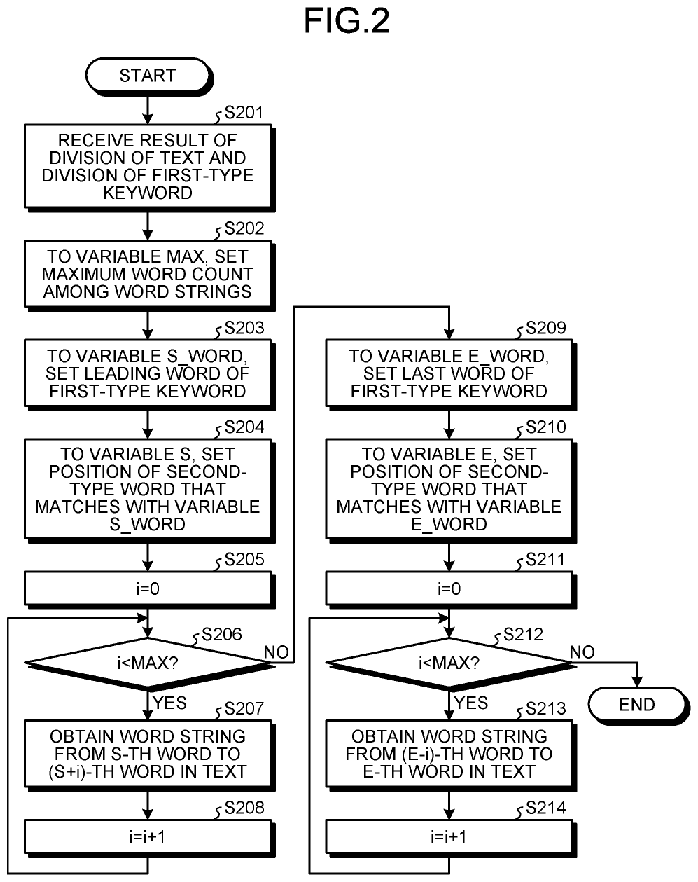

FIG. 2 is a flowchart for explaining an example of the operations performed by the extracting unit 102 according to the first embodiment. Firstly, from the dividing unit 101, the extracting unit 102 receives a first-type keyword divided into first-type words and receives a text divided into second-type words (Step S201).

Then, the extracting unit 102 sets, in a variable MAX, the maximum word count among the extracted word strings (Step S202).

Subsequently, the extracting unit 102 sets, to a variable S_WORD, the leading first-type word of the first-type keyword (Step S203).

Then, the extracting unit 102 sets, to a variable S, the position of the second-type word that matches with the variable S_WORD (Step S204).

Subsequently, the extracting unit 102 sets an initial value “0” in a variable i (Step S205). Then, the extracting unit 102 determines whether or not i<MAX holds true (Step S206).

If i<MAX holds true (Yes at Step S206), then the extracting unit 102 obtains the word string from the S-th word to the (S+i)-th word in the text (Step S207). Subsequently, the extracting unit 102 increments the variable i by one (Step S208), and the system control returns to Step S206.

On the other hand, if i<MAX does not hold true (No at Step S206), then the system control proceeds to Step S209.

Subsequently, the extracting unit 102 sets, to a variable E_WORD, the last first-type word of the first-type keyword (Step S209).

Then, the extracting unit 102 sets, to a variable E, the position of the second-type word that matches with the variable E_WORD (Step S210).

Subsequently, the extracting unit 102 sets an initial value “0” in the variable i (Step S211). Then, the extracting unit 102 determines whether or not i<MAX holds true (Step S212).

If i<MAX holds true (Yes at Step S212), then the extracting unit 102 obtains the word string from the (E-i)-th word to the E-th word in the text (Step S213). Then, the extracting unit 102 increments the variable i by one (Step S214), and the system control returns to Step S212.

On the other hand, if i<MAX does not hold true (No at Step S212), then it marks the end of the operations.

Meanwhile, at Step S204, if a plurality of second-type words in the text matches with the variable S_WORD, the positions of all second-type words are set to the variable S, and the operations from Step S205 to Step S208 are performed for each value of the variable S.

Similarly, if a plurality of second-type words in the text match with the variable E_WORD, the positions of all second-type words are set to the variable E, and the operations from Step S211 to Step S214 are performed for each value of the variable E.

### Specific Example of Extraction Operation

For example, assume that the extracting unit 102 receives, from the dividing unit 101, the text and the first-type keyword as given below. Herein, the slash marks “/” indicate the divisions of the text.

Text: “ [symbol] [symbol] 21 [symbol] ”

First-type keyword: “ [symbol] ”

If the maximum word count among the obtained word strings is specified to be “7” (i.e., if MAX=7 holds true), then the following 11 word strings are obtained as a result of the operations performed by the extracting unit 102.

“ [symbol] ”

“ [symbol] ”

“ [symbol] ”

“ [symbol] ”

“ [symbol] ”

“ [symbol] 8”

“ [symbol] 8 [symbol] ”

“ [symbol] ”

“ [symbol] ”

“ [symbol] ”

“ [symbol] ”

### Example of Operations of Detecting Unit

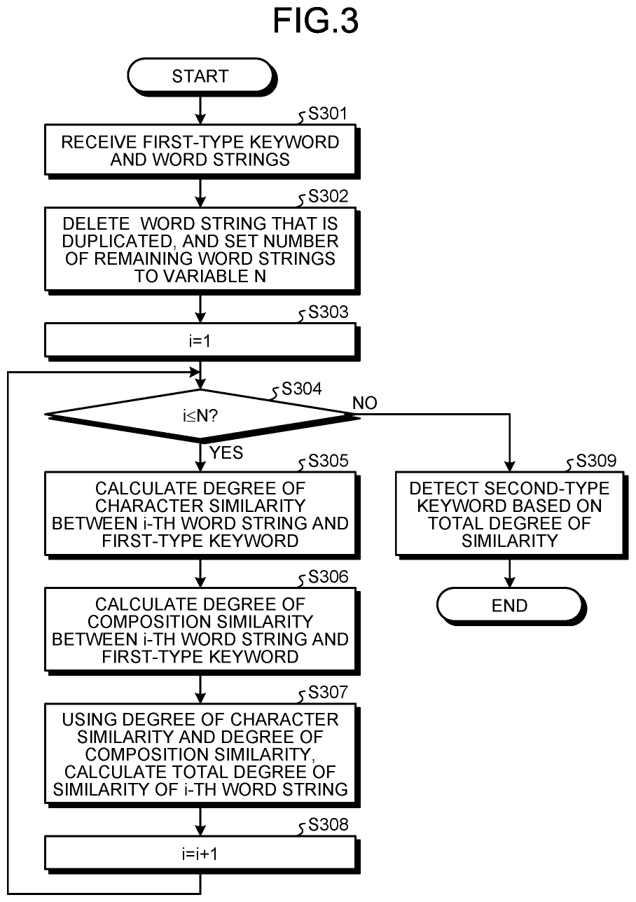

FIG. 3 is a flowchart for explaining an example of the operations performed by the detecting unit 103 according to the first embodiment. Firstly, the detecting unit 103 receives, from the extracting unit 102, a first-type keyword and word strings (Step S301).

If a plurality of word strings is received at Step S301, then the detecting unit 103 deletes a word string that is duplicated and sets the number of remaining word strings to a variable N (Step S302). Subsequently, the detecting unit 103 sets an initial value “1” in the variable i (Step S303).

Subsequently, the detecting unit 103 determines whether or not i≤N holds true (Step S304). If i≤N holds true (Yes at Step S304), then the detecting unit 103 calculates the degree of character similarity between the i-th word string and the first-type keyword (Step S305).

The degree of character similarity indicates the degree of similarity of the characters. For example, the degree of character similarity can be obtained using the cosine similarity or the Levenshtein distance. Herein, it is implied that the similarity is proportional to the value of the degree of similarity. On the other hand, it is implied that the similarity is inversely proportional to the distance. Hence, in the case of using the distance, either the reciprocal thereof is used; or standardization is performed to fit the distance between “0” and “1” and then that value is subtracted from “1” so as to obtain a numerical value which implies direct proportionality with the similarity.

Subsequently, the detecting unit 103 calculates the degree of composition similarity indicating the similarity between the composition of the i-th word string and the composition of the first-type keyword (Step S306).

For example, the degree of composition similarity is set based on the number of second-type words, from among the second-type words included in the word string, that match with the first-type words. For example, the word string “ [symbol] ” includes the second-type word “ [symbol] ” that matches with a first-type word constituting the first-type keyword. Hence, the degree of composition similarity becomes equal to “1”. Similarly, a character string “ [symbol] ” includes the second-type words “ [symbol] ” and “ [symbol] ” that match with the first-type words constituting the first-type keyword. Hence, the degree of composition similarity becomes equal to “2”.

Then, based on at least either the degree of character similarity or the degree of composition similarity, the detecting unit 103 calculates the total degree of similarity of the i-th word string (Step S307).

For example, the total degree of similarity can be obtained using Equation (1) given below. Herein, Sim represents the total degree of similarity; Sim_chr represents the degree of character similarity; Sim_com represents the degree of composition similarity; and α and β represent coefficients satisfying 0≤α≤1 and 0≤β≤1, respectively.

Sim=(α×Sim_chr)+(β×Sim_com) (1)

Subsequently, the detecting unit 103 increments the variable i by one (Step S308), and the system control returns to Step S304.

Meanwhile, if i≤N does not hold true (No at Step S304), then the detecting unit 103 detects the second-type keyword based on the total degree of similarity (Step S309).

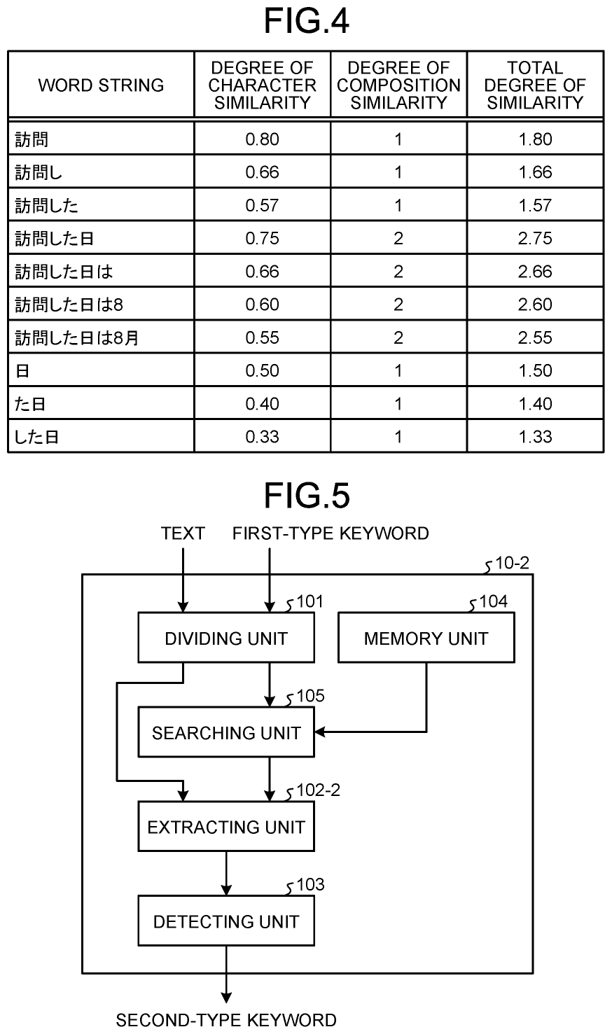

FIG. 4 is a diagram illustrating an example of the processing result obtained by the detecting unit 103 according to the first embodiment. In the example illustrated in FIG. 4, the total degree of similarity is calculated by setting α=1 and β=1 in Equation (1). In this example, the word string “ [symbol] ” has the highest total degree of similarity equal to 2.75. In that case, the detecting unit 103 detects, for example, the word string “ [symbol] ” as the second-type keyword.

As explained above, in the information processing device 10 according to the first embodiment, the dividing unit 101 divides the first-type keyword into first-type words, and divides the text into second-type words. The extracting unit 102 extracts, from the text, at least either a word string in which the second-type word matching with the leading first-type word of the first-type keyword is included as the leading word, or a word string in which the second-type word matching with the last first-type word of the first-type keyword is included as the last word. Then, the detecting unit 103 detects the second-type keyword at least either based on the degree of character similarity indicating the similarity between the characters of the extracted word string and the characters of the first-type keyword, or based on the degree of composition similarity indicating the similarity between the composition of the extracted word and the composition of the first-type keyword.

As a result, in the information processing device 10 according to the first embodiment, even if there are no expressions matching with the predefined item names, it becomes possible to identify the slots in which the item values are to be set. For example, it becomes possible to detect the similar expressions from the utterance and to identify the slots, without having to prepare for the paraphrastic expressions of the item names.

### SECOND EMBODIMENT

Given below is the explanation of a second embodiment. In the second embodiment, the identical explanation to the first embodiment is not repeated, and the explanation is given only about the differences with the first embodiment.

### Exemplary Functional Configuration

FIG. 5 is a diagram illustrating an exemplary functional configuration of an information processing device 10-2 according to the second embodiment. The information processing device 10-2 includes the dividing unit 101, an extracting unit 102-2, the detecting unit 103, a memory unit 104, and a searching unit 105.

With reference to FIG. 5, the constituent elements identical to the first embodiment are referred to by the same reference numerals, and the following explanation is given only about the differences. With reference to FIG. 5, the memory unit 104 and the searching unit 105 are newly included, and the extracting unit 102-2 is substituted for the extracting unit 102.

The memory unit 104 is used to store a thesaurus. The thesaurus can be prepared for each user or for each set of form data (report).

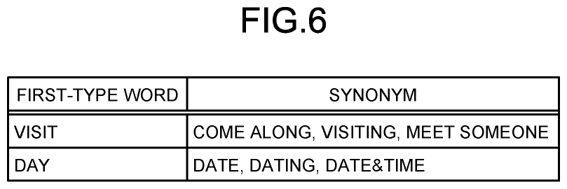

FIG. 6 is a diagram illustrating an example of the thesaurus according to the second embodiment. When synonyms that are similar to first-type words are available; for example, the synonyms are registered for each first-type word as illustrated in FIG. 6.

The searching unit 105 searches for the synonyms that are similar to a first-type word by using the thesaurus. For example, the searching unit 105 searches for the synonyms that are similar to the leading first-type word of the first-type keyword as well as searches for the synonyms that are similar to the last first-type word of the first-type keyword. For example, when “ [symbol] ”/“visit day” represents the first-type keyword, the words “ [symbol] ”/“come along (or visit)”, “ [symbol] ”/“visiting”, and “ [symbol] ”/“meet someone” are retrieved as the synonyms that are similar to the leading first-type word “ [symbol] ”/“visit”; and the words “ [symbol] ”/“date”, “ [symbol] ”/“dating (date)”, and “ [symbol] ”/“date&time” are retrieved as the synonyms that are similar to the last first-type word “ [symbol] ”/“day”.

The extracting unit 102-2 further extracts, from the text, at least either a word string in which the second-type word matching with a synonym that is similar to the leading first-type word of the first-type keyword is included as the leading word, or a word string in which the second-type word matching with a synonym that is similar to the last first-type word of the first-type keyword is included as the last word.

### Example of Operations of Extracting Unit

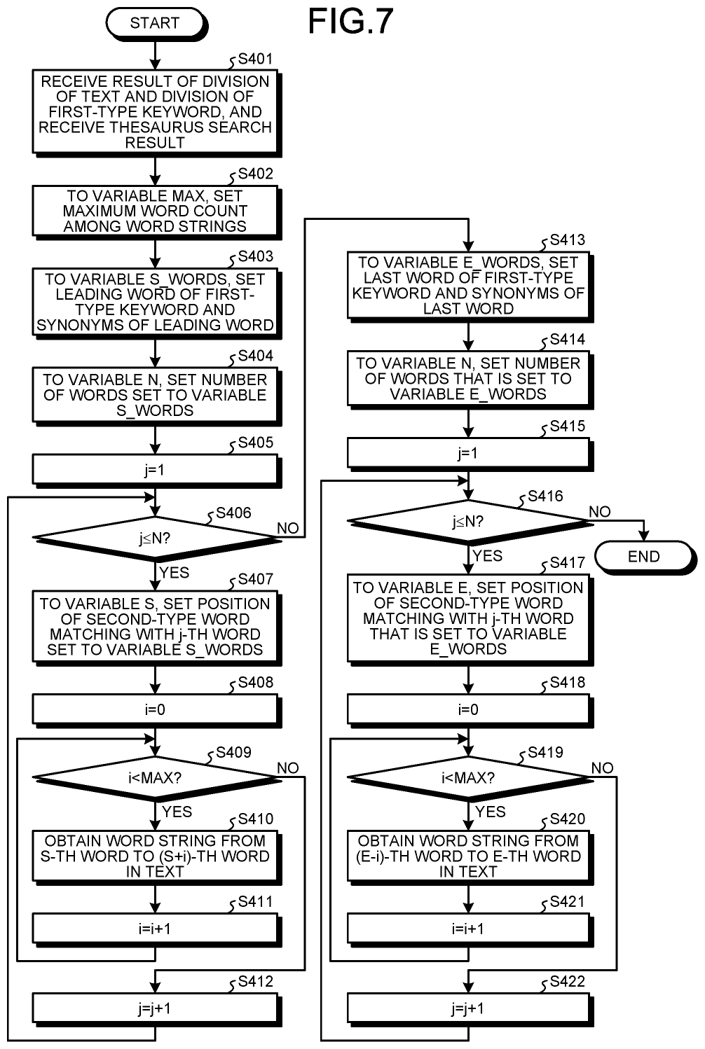

FIG. 7 is a flowchart for explaining an example of the operations performed by the extracting unit 102-2 according to the second embodiment. Firstly, from the dividing unit 101, the extracting unit 102-2 receives a first-type keyword divided into first-type words and receives a text divided into second-type words, as well as receives the thesaurus search result from the searching unit 105 (Step S401).

In the example illustrated in FIG. 7, the thesaurus search result includes the synonyms that are similar to the leading first-type word of the first-type keyword and includes the synonyms that are similar to the last first-type word of the first-type keyword.

Then, the extracting unit 102-2 sets, to the variable MAX, the maximum word count among the extracted word strings (Step S402).

Subsequently, the extracting unit 102-2 sets, to a variable S_WORDS, the leading first-type word of the first-type keyword and the synonyms that are similar to that first-type word (Step S403).

Then, the extracting unit 102-2 sets, to the variable N, the number of words (the first-type words and the synonyms that are similar to the first-type word) set in the variable S_WORDS. (Step S404).

Subsequently, the extracting unit 102-2 sets an initial value “1” in a variable j (Step S405). Then, the extracting unit 102-2 determines whether or not j≤N holds true (Step

S406).

If j≤N holds true (Yes at Step S406), then the extracting unit 102-2 sets, to the variable S, the position of the second-type word matching with the j-th word that is set to the variable S_WORDS (Step S407).

The subsequent operations performed from Step S408 to Step S411 are identical to the operations performed from Step S205 to Step S208 (see FIG. 2) according to the first embodiment. Hence, that explanation is not given again.

If i<MAX does not hold true (No at Step S409), then the extracting unit 102-2 increments the variable j by “1” (Step S412), and the system control returns to 406.

Moreover, if j≤N does not hold true (No at Step S406), then the extracting unit 102-2 sets, to a variable E_WORDS, the last first-type word of the first-type keyword and the synonyms that are similar to that first-type word (Step S413).

Then, the extracting unit 102-2 sets, to the variable N, the number of words that is set to the variable E_WORDS (i.e., the number of words including the first-type word and the synonyms that are similar to the first-type word) (Step S414).

Subsequently, the extracting unit 102-2 sets an initial value “1” in the variable j (Step S415). Then, the extracting unit 102-2 determines whether or not j≤N holds true (Step S416).

If j≤N holds true (Yes at Step S416), then the extracting unit 102-2 sets, to the variable E, the position of the second-type word matching with the j-th word that is set to the variable E_WORDS (Step S417).

The operations performed from Step S418 to Step S421 are identical to the operations performed from Step S211 to Step S214 (see FIG. 2) according to the first embodiment. Hence, that explanation is not given again.

If i<MAX does not hold true (No at Step S419), then the extracting unit 102-2 increments the variable j by “1” (Step S422), and the system control returns to 416.

Moreover, if j≤N does not hold true (No at Step S416), then it marks the end of the operations.

Meanwhile, in the case searching for the matching words at Step S407 and Step S417, the extracting unit 102-2 compares the original forms of the concerned words.

### Specific Example of Extraction Operation

For example, assume that the extracting unit 102-2 receives, from the dividing unit 101, the text and the first-type keyword as given below. Herein, the slash marks “/” indicate the divisions of the text.

Text: “ [symbol] [symbol] 21 [symbol] ”

First-type keyword: “ [symbol] ”

The text neither includes the leading word “ [symbol] ” of the first-type keyword nor includes the last word “ [symbol] ” of the first-type keyword. However, the text includes the respective synonyms, namely, “ [symbol] ”/“visit” and “ [symbol] ”/“date”. Hence, as a result of the operations performed by the extracting unit 102-2, the word string “ [symbol] ”/“visited day” is detected. Using that extraction result, “ [symbol] ”/“visited day” gets detected as the second-type keyword during the operations performed by the detecting unit 103.

In the information processing device 10-2 according to the second embodiment, by using a thesaurus, even if there are no expressions matching with the predefined item names, it becomes possible to further enhance the performance of the operations for identifying the slots in which the item values are to be set.

### THIRD EMBODIMENT

Given below is the explanation of a third embodiment. In the third embodiment, the identical explanation to the first embodiment is not repeated, and the explanation is given only about the differences with the first embodiment.

### Exemplary Functional Configuration

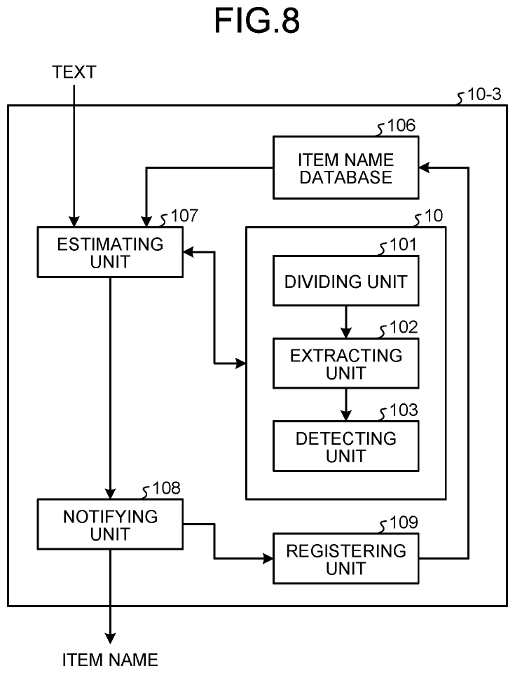

FIG. 8 is a diagram illustrating an exemplary functional configuration of an information processing device 10-3 according to the third embodiment. The information processing device 10-3 includes the dividing unit 101, the extracting unit 102, the detecting unit 103, an item name database 106, an estimating unit 107, a notifying unit 108, and a registering unit 109.

With reference to FIG. 8, the constituent elements identical to the first embodiment are referred to by the same reference numerals, and the following explanation is given only about the differences. Moreover, with reference to FIG. 8, the item name database 106, the estimating unit 107, the notifying unit 108, and the registering unit 109 are newly included. Herein, the dividing unit 101, the extracting unit 102, and the detecting unit 103 operate as the subprocesses of the estimating unit 107. In the third embodiment, the input is only in the form of a text, and all item names registered in the item name database 106 are equivalent to the first-type keyword illustrated in FIG. 1.

In the item name database 106, the item names are stored in association with the their paraphrastic expressions. The item name database 106 can be prepared for each user or for each set of form data (report).

### Examples of Item Name Database

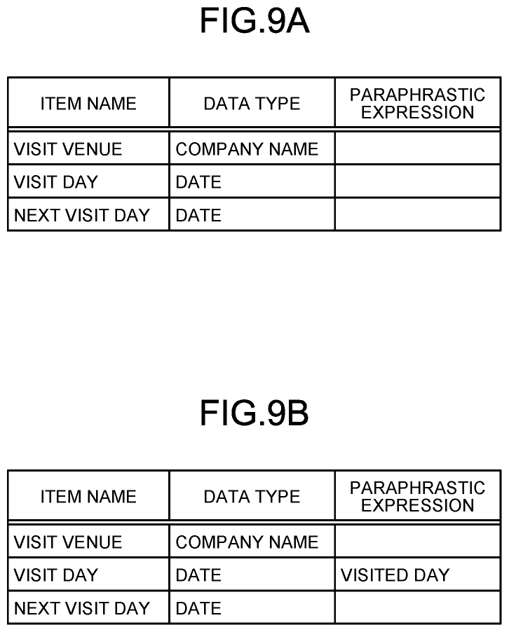

FIG. 9A is a diagram illustrating a first example of the item name database according to the third embodiment. FIG. 9B is a diagram illustrating a second example of the item name database according to the third embodiment. The item name database 106 includes the following fields: “item name”, “data type”, and “paraphrastic expression”. The field “item name” includes the items included in the form data. The field “data type” includes the data types of the data input in the slots (item fields) identified by the item names. The field “paraphrastic expression” includes the paraphrastic expressions of the item names. Herein, the fields “item name” and “data type” are mandatory fields, while the field “paraphrastic expression” can be an empty field (see FIG. 9A).

Returning to the explanation with reference to FIG. 8, the estimating unit 107 activates the dividing unit 101, the extracting unit 102, and the detecting unit 103 as, for example, subprocesses; and detects, from the text, the second-type keywords corresponding to the item names stored in the item name database 106; and estimates the item names. Regarding the operations performed by the estimating unit 107, the detailed explanation is given later.

The notifying unit 108 notifies the user about the processing result of the estimating unit 107. Regarding the operations performed by the notifying unit 108, the detailed explanation is given later.

The registering unit 109 registers the detected second-type keyword in the item name database 106 based on the processing result obtained by the estimating unit 107 and the notifying unit 108. Regarding the operations performed by the registering unit 109, the detailed explanation is given later.

### Example of Operations of Estimating Unit

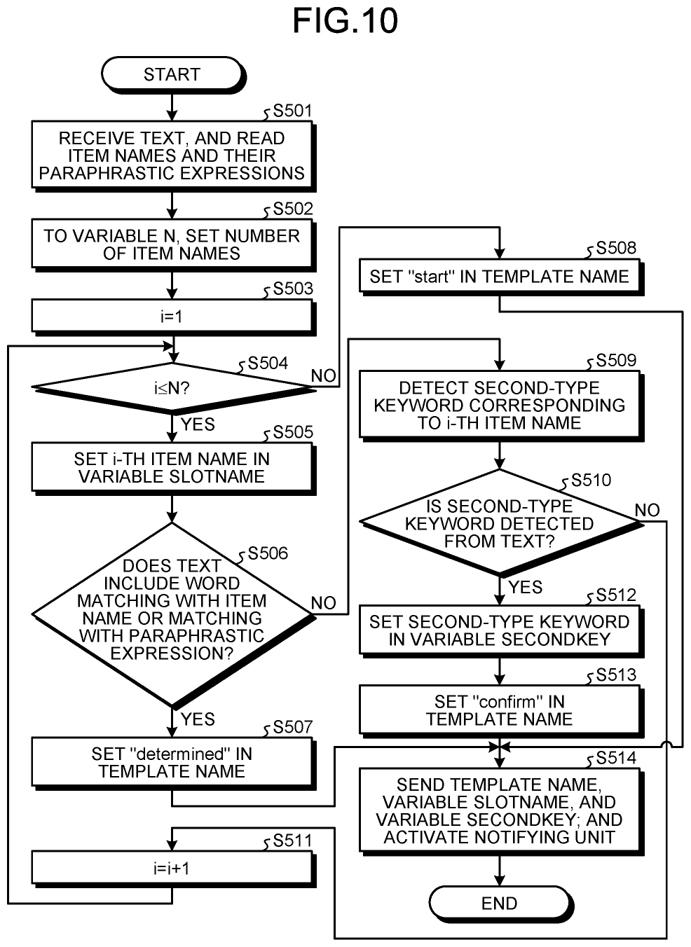

FIG. 10 is a flowchart for explaining an example of the operations performed by the estimating unit 107 according to the third embodiment. Firstly, the estimating unit 107 receives a text and reads the corresponding item names and their paraphrastic expressions from the item name database 106 (Step S501). For example, the estimating unit 107 receives a text that is obtained by performing speech recognition of a user utterance.

Then, the estimating unit 107 sets the number of item names to the variable N (Step S502). Subsequently, the estimating unit sets an initial value “1” in the variable i (Step S503).

Then, the estimating unit 107 determines whether or not i≤N holds true (Step S504).

If i≤N holds true (Yes at Step S504), then the estimating unit 107 sets the i-th item name in a variable SLOTNAME (Step S505).

Subsequently, regarding the i-th item name, the estimating unit 107 determines whether or not the text includes a word (second-type word) matching with the item name or matching with a paraphrastic expression of the item name (Step S506).

If a matching word is present (Yes at Step S506), then the estimating unit 107 sets “determined” in the template name of a response sentence template (Step S507), and the system control proceeds to Step S514.

The following explanation is given about the response sentence template.

### Example Of Response Sentence Template

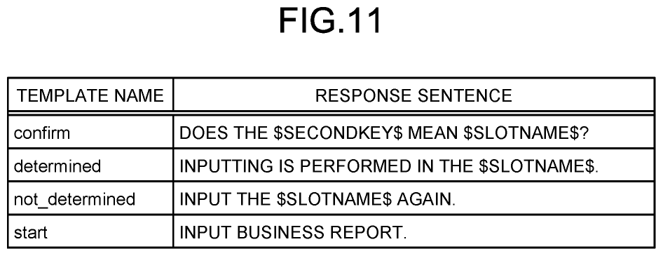

FIG. 11 is a diagram illustrating an example of the response sentence template according to the third embodiment. The response sentence template includes a “template name” field and a “response sentence” field. In the “response sentence” field, a character string enclosed by the “$” symbols represents a variable set by the estimating unit 107. For example, if “ [symbol] ”/“visited day” is set in a variable SECONDKEY and if “ [symbol] ”/“visit day” is set in the variable SLOTNAME, then the response sentence corresponding to a template name “confirm” indicates “ [symbol] [symbol] [symbol] ?”/“Does the visited day mean visit day?”.

Returning to the explanation with reference to FIG. 10, the explanation of the operations performed by the estimating unit 107 is continued below.

When a matching word is not present (No at Step S506), the estimating unit 107 activates the dividing unit 101, the extracting unit 102, and the detecting unit 103; and detects the second-type keyword corresponding to the i-th item name (Step S509).

Subsequently, regarding the i-th item name, the estimating unit 107 determines whether or not the second-type keyword is detected from the text (Step S510).

If the second-type keyword is detected (Yes at Step S510), then the estimating unit 107 sets the second-type keyword in the variable SECONDKEY (Step S512). Subsequently, the estimating unit 107 sets “confirm” in the “template name” field of the response sentence template (Step S513). Then, the system control proceeds to Step S514.

On the other hand, if the second-type keyword is not detected (No at Step S510), then the estimating unit 107 increments the variable i by one (Step S511). Then, the system control returns to Step S504.

Meanwhile, if i≤N does hold true (No at Step S504), then the estimating unit 107 sets “start” in the “template name” field of the response sentence template (Step S508). Then, the system control proceeds to Step S514.

At Step S514, the estimating unit 107 sends the template name, the variable SLOTNAME, and the variable SECONDKEY; and activates the notifying unit 108.

### Example of Operations of Notifying Unit

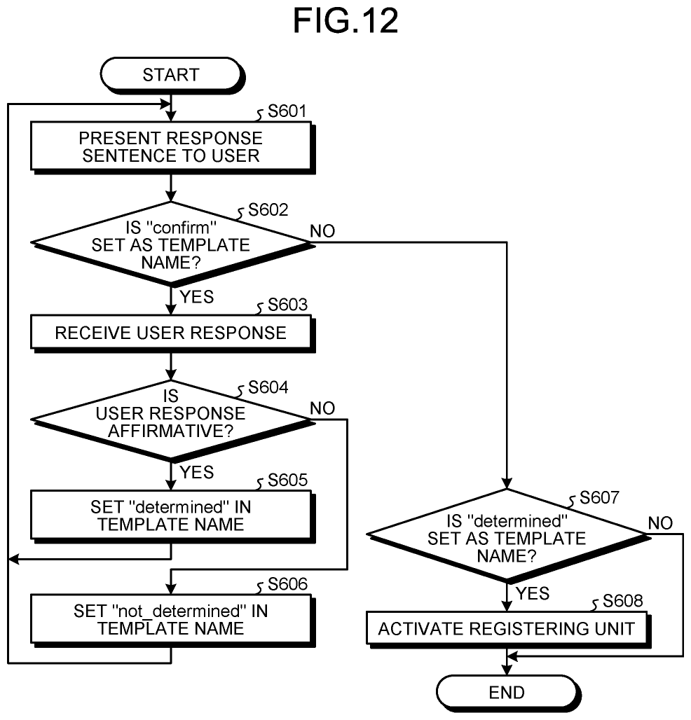

FIG. 12 is a flowchart for explaining an example of the operations performed by the notifying unit 108 according to the third embodiment. Firstly, the notifying unit 108 generates a response sentence using the template name specified in the operation performed by the estimating unit 107 at Step S514; and presents the response sentence to the user (Step S601).

Then, the notifying unit 108 determines whether or not “confirm” is set as the template name (Step S602).

If “confirm” is set as the template name (Yes at Step S602), then the notifying unit 108 receives the response from the user (Step S603).

Subsequently, the notifying unit 108 determines whether or not the response from the user is affirmative (Step S604). The determination about whether or not the response from the user is affirmative is performed according to whether or not the user utterance includes a specific keyword such as “Yes” or “No”. Alternatively, the determination about whether or not the response from the user is affirmative can be performed by asking the user to select an “OK” button or an “NO” button in a user interface.

If the response is affirmative (Yes at Step S604), then the notifying unit 108 sets “determined” in the template name (Step S605), and the system control returns to 601. However, if the response is not affirmative (No at Step S604), then the notifying unit 108 sets “not_determined” in the template name (Step S606), and the system control returns to 601.

Meanwhile, if “confirm” is not the template name (No at Step S602), then the notifying unit 108 determines whether or not “determined” is set as the template name (Step S607).

If “determined” is set as the template name (Yes at Step S607), then the notifying unit 108 activates the registering unit 109 (Step S608). However, if “determined” is not the template name (No at Step S607), then it marks the end of the operations.

### Specific Example of Notification Operation

For example, assume that, when the information illustrated in FIG. 9A is stored in the item name database 106, the following text is received as input in the information processing device 10-2. Herein, the slash marks “/” indicate the divisions of the text.

Text: “ [symbol] [symbol] 21 [symbol] ”

The text does not include any word (second-type word) matching with “ [symbol] ”, or matching with “ [symbol] ” , or matching with “ [symbol] ”. As a result of the operations performed by the dividing unit 101, the extracting unit 102, and the detecting unit 103; the second-type keyword “ [symbol] ” is detected corresponding to the item name “ [symbol] ”. Moreover, as a result of the operations performed by the estimating unit 107, the following information is set:

SLOTNAME=“ [symbol] ”

SECONDKEY=“ [symbol] ”

template name=“confirm”

Then, the notifying unit 108 is activated. As a result of the operations performed by the notifying unit 108, a response sentence indicating “ [symbol] [symbol] [symbol] ?”/“Does the visited day mean visit day?” is generated and is presented to the user.

When an affirmative response such as “Yes” is received from the user, the notifying unit 108 sets “determined” in the template name and presents a response sentence indicating “ [symbol] [symbol] ”/“inputting is performed in the visit day.” to the user.

Moreover, as a result of the operations performed by the registering unit 109, the term “ [symbol] ” is registered as the paraphrastic expression of the item name “ [symbol] ” in the item name database 106. Hence, the item name database 106 gets updated as illustrated in FIG. 9B.

Meanwhile, regarding whether or not the registering unit 109 should perform the operation, the notifying unit 108 can make the decision by confirming, in advance, with the user about whether or not the term “ [symbol] ” is to be registered as the paraphrastic expression of the item name “ [symbol] ”.

Meanwhile, when a non-affirmative response such as “No” is received from the user, the notifying unit 108 sets “not_determined” in the template name and presents a response sentence such as “ [symbol] [symbol] [symbol] ”/“Input the visit day again.” to the user as a notification that the item name cannot be identified.

In the information processing device 10-3 according to the third embodiment, the paraphrastic expressions in the item name database 106 can be more appropriately updated using the functions of the information processing device 10 according to the first embodiment.

Lastly, the explanation is given about an exemplary hardware configuration of the information processing devices 10 to 10-3 according to the first to third embodiments.

### Exemplary Hardware Configuration

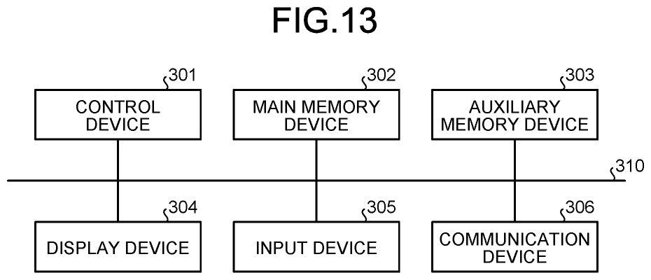

FIG. 13 is a diagram illustrating an exemplary hardware configuration of the information processing devices 10 to 10-3 according to the first to third embodiments. Since the information processing devices 10 to 10-3 have an identical hardware configuration, the following explanation is given only about the information processing device 10.

The information processing device 10 includes a control device 301, a main memory device 302, an auxiliary memory device 303, a display device 304, an input device 305, and a communication device 306. Herein, the control device 301, the main memory device 302, the auxiliary memory device 303, the display device 304, the input device 305, and the communication device 306 are connected to each other via a bus 310.

The control device 301 executes a computer program that has been read from the auxiliary memory device 303 into the main memory device 302. The main memory device 302 is a memory such as a read only memory (ROM) or a random access memory (RAM). The auxiliary memory device 303 is a hard disk drive (HDD), or a solid state drive (SSD), or a memory card.

The display device 304 is used to display the display information. The display device 304 is, for example, a liquid crystal display. The input device 305 is an interface for enabling operation of the computer. The input device 305 is, for example, a keyboard or a mouse. If the computer is a smart device such as a smartphone or a tablet terminal, then the display device 304 and the input device 305 are integrated into, for example, a touch-sensitive panel. The communication device 306 is an interface for enabling communication with other devices.

The computer program executed in the computer is recorded as an installable file or an executable file in a computer-readable memory medium such as a compact disc read only memory (CD-ROM), a memory card, a compact disc recordable (CD-R), or a digital versatile disc (DVD); and is provided as a computer program product.

Alternatively, the computer program executed in the computer can be stored in a downloadable manner in a computer connected to a network such as the Internet. Still alternatively, the computer program executed in the computer can be distributed via a network, such as the Internet, without involving any downloading.

Still alternatively, the computer program executed in the computer can be stored in advance in a ROM.

The computer program executed in the computer includes modules of such function blocks, from among the functional configuration (function blocks) of the information processing device 10, which can be implemented using a computer program. As far as the actual hardware is concerned, when the control device 301 reads the computer program from the memory medium and executes it, the function blocks get loaded in the main memory device 302. That is, the function blocks are generated in the main memory device 302.

Meanwhile, some or all of the function blocks can be implemented using hardware, such as an integrated circuit (IC), instead of using software.

In the case of implementing the functions using a plurality of processors, each processor can implement one of the functions or can implement two or more functions.

The computer that is used to implement the information processing device 10 can have an arbitrary operation mode. For example, the information processing device 10 can be implemented using a single computer. Alternatively, for example, the information processing device 10 can be operated as a cloud system in a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a hardware processor configured to function as:
a dividing unit that
divides a first-type keyword into first-type words, and
divides a text into second-type words;
an extracting unit that extracts, from the text,
at least either a word string in which a second-type word matching with a leading first-type word of the first-type keyword is included as a leading word, or
a word string in which the second-type word matching with a last first-type word of the first-type keyword is included as a last word; and
a detecting unit that detects a second-type keyword based on
at least either a degree of character similarity indicating a similarity in character between the word string and the first-type keyword, or
a degree of composition similarity indicating a similarity in composition between the word string and the first-type keyword.

2. The information processing device according to claim 1,
wherein
the hardware processor is configured to further function as a searching unit that searches for synonyms that are similar to the first-type words by using a thesaurus, and
the extracting unit further extracts, from the text,
at least either a word string in which the second-type word matching with a synonym that is similar to the leading first-type word of the first-type keyword is included as the leading word, or
a word string in which the second-type word matching with a synonym that is similar to the last first-type word of the first-type keyword is included as the last word.

3. The information processing device according to claim 1, wherein
the text is obtained by performing speech recognition of user utterance,
the first-type keyword indicates item name included in form data, and
the hardware processor is configured to further function as an estimating unit that estimates the item name from the second-type keyword.

4. The information processing device according to claim 3, further comprising a memory unit that is used to store therein the item name in association with paraphrastic expression of the item name, wherein
the hardware processor is configured to further function as a registering unit that registers the second-type keyword as the paraphrastic expression in the memory unit.

5. The information processing device according to claim 4, wherein the hardware processor is configured to further function as a notifying unit that
confirms with the user about whether or not the second-type keyword corresponds to the item name, and
when the second-type keyword does not correspond to the item name, notifies that the item name is not identifiable.

6. The information processing device according to claim 4, wherein the hardware processor is configured to further function as a notifying unit that
confirms with the user about whether or not to register the second-type keyword as the paraphrastic expression, and
when registering the second-type keyword as the paraphrastic expression, requests the registering unit to register the second-type keyword.

7. The information processing device according to claim 1, wherein the degree of character similarity is set based on at least either cosine similarity or Levenshtein distance.

8. The information processing device according to claim 1, wherein the degree of composition similarity is set based on a number of second-type words that, from among the second-type words included in the word string, match with the first-type words.

9. An information processing method implemented by a computer, the method comprising:
by an information processing device,
dividing a first-type keyword into first-type words, and dividing a text into second-type words;
extracting, from the text,
at least either a word string in which the second-type word matching with a leading first-type word of the first-type keyword is included as a leading word, or
a word string in which the second-type word matching with a last first-type word of the first-type keyword is included as a last word; and
detecting a second-type keyword based on
at least either a degree of character similarity indicating a similarity in character between the word string and the first-type keyword, or
a degree of composition similarity indicating a similarity in composition between the word string and the first-type keyword.

10. A computer program product having a non-transitory computer readable medium including programmed instructions stored therein, wherein the instructions, when executed by a computer, cause the computer to function as:
a dividing unit that
divides a first-type keyword into first-type words, and
divides a text into second-type words;
an extracting unit that extracts, from the text,
at least either a word string in which the second-type word matching with a leading first-type word of the first-type keyword is included as a leading word, or
a word string in which the second-type word matching with a last first-type word of the first-type keyword is included as a last word; and
a detecting unit that detects a second-type keyword based on
at least either a degree of character similarity indicating a similarity in character between the word string and the first-type keyword, or
a degree of composition similarity indicating a similarity in composition between the word string and the first-type keyword.
